(19) United States
(12) Patent Application Publication
(10) Pub. No.: US 2007/0097512 A1
(43) Pub. Date: May 3, 2007

(54) Compound-eye imaging device

(75) Inventors: Takashi Toyoda, Osaka (JP); Yoshizumi Nakao, Osaka (JP); Yasuo Masaki, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/586,603

(22) Filed: Oct. 26, 2006

(30) Foreign Application Priority Data
Oct. 27, 2005 (JP) 2005-312866

(51) Int. Cl. G02B 27/10

(52) U.S. Cl. 359/626

(57) ABSTRACT

A compound-eye imaging device comprises: an optical lens array with integrated optical lenses; a stop member for shielding unnecessary ambient light from entering the optical lens array; a photodetector array placed at a predetermined distance from the optical lens array for imaging images formed by the optical lenses; and a light shielding block placed between the two arrays for partitioning a space between the two arrays into a matrix of spaces as seen on a plane perpendicular to the optical axis of each optical lens to prevent lights from the optical lenses from interfering each other. The optical lenses are formed of a molded glass having a refractive index distribution to increase the refractive index of each optical lens in the direction of light propagation. The focal length of each optical lens can be reduced as compared with an ordinary lens, thereby reducing the thickness of the compound-eye imaging device.

### BACKGROUND OF THE INVENTION

1. Field of the Invention

The present invention relates to a compound-eye imaging device having an optical imaging system which is formed of multiple micro optical systems so as to reduce the focal length, enabling reducing the thickness of the compound-eye imaging device.

2. Description of the Related Art

There has been developed a compound-eye imaging device as a thin camera module to be installed in a cellular phone, a personal computer, or the like. The compound-eye imaging device is mainly composed of: an optical lens array with multiple integrated optical lenses having optical axes parallel to each other; a photodetector array for imaging multiple single-eye images formed by the respective optical lenses of the optical lens array; and an image reconstructing circuit for reconstructing the multiple single-eye images, imaged by the photodetector array, into one image by using parallax information between the multiple single-eye images.

On the other hand, a rod lens array is known as an optical component for projecting an image at the same magnification as that of an object on line onto a sensor or a photosensitive drum in a facsimile machine or an electronic copying machine. It is also known to use an optical component having a refractive index distribution in a certain direction relative to the direction of light propagation so as to achieve a function equivalent to that of the rod lens array with components having reduced sizes (refer to e.g. Japanese Laid-open Patent Publication Hei 6-347720).

Besides, it is known to use optical patterning or dry etching as a method of efficiently manufacturing a microlens array (refer to e.g. Japanese Laid-open Patent Publication Hei 6-194502 and Japanese Laid-open Patent Publication 2004-279588). Furthermore, an image-forming optical device is known in which rod lenses having a refractive index distribution in the radial direction are placed in an array to form a rod lens array (refer to e.g. Japanese Laid-open Patent Publication 2002-228923).

It is thus possible to reduce the focal length and thickness of a compound-eye imaging device by forming an imaging optical system using multiple micro optical lenses placed in an array along with a photodetector array for imaging multiple images formed at focal points of the respective optical lenses. Here, one way to further reduce the thickness of the compound-eye imaging device may be to reduce the size of, and increase the integration density of, the optical lenses.

However, there are problems in reducing the size of each optical lens, and increasing the integration density of the optical lenses. That is, first, this causes a difficulty in manufacturing. Second, the increase in the number of optical lenses causes the number of single-eye images formed on the photodetector array to increase, so that it takes a long time to reconstruct the single-eye images into one image by using parallax information between the single-eye images. Under certain conditions or applications, there are an optimum number of optical lenses and an optimum size of the optical lenses. Depending on the number of optical lenses and the size of the optical lenses, there is a limit in the reduction of the focal length of each optical lens.

Note that the technology according to the above-described Japanese Laid-open Patent Publication Hei 6-347720uses a material having a refractive index distribution for the purpose of forming an erected image on a photosensitive drum e.g. of a facsimile machine. Further, the above-described Japanese Laid-open Patent Publication Hei 6-194502 and Japanese Laid-open Patent Publication 2004-279588 do not relate to an optical lens array to be used for a compound-eye imaging device, but to technologies for manufacturing finer microlens arrays.

The inventors of the present invention have paid attention to a glass material having a refractive index distribution used e.g. for a rod lens array in a facsimile machine, in which the refractive index varies (increases or decreases) in the direction of light propagation. Using optical simulation, the present inventors have demonstrated the possibility that the use of such glass material for optical lenses in a compound-eye imaging device may further reduce the focal length of the optical lenses.

### SUMMARY OF THE INVENTION

An object of the present invention is to provide a compound-eye imaging device which can be reduced in its thickness without either causing difficulties in manufacturing or causing a problem that it takes a long time to reconstruct an image.

According to the present invention, this object is achieved by a compound-eye imaging device comprising: an optical lens array with multiple integrated optical lenses; a stop member for shielding unnecessary ambient light from entering the optical lens array; a photodetector array placed at a predetermined distance from the optical lens array for imaging images formed by the optical lenses, respectively; and a light shielding block placed between the optical lens array and the photodetector array for partitioning a space between the optical lens array and the photodetector array into a matrix of spaces as seen on a plane perpendicular to the optical axis of each optical lens to lights emitted from the optical lenses from interfering each other.

The optical lenses of the optical lens array are formed of a molded glass having a refractive index distribution such that the refractive index of each of the optical lenses increases in the direction of light propagation from a light entrance to a light exit of the each of the optical lenses.

The compound-eye imaging device according to the present invention makes it possible to reduce the focal length of each optical lens, as compared with the case of forming an optical lens array or optical lenses by using an ordinary glass material, thereby reducing the thickness of the compound-eye imaging device without either causing a difficulty in manufacturing or causing a problem of taking a long time to reconstruct an image.

The compound-eye imaging device can be designed so that the optical lenses have optical axes parallel to each other, and are integrally formed with a glass substrate to form the optical lens array.

Preferably, the optical lens array is formed of a molded glass substrate formed by vertically compressing a glass plate in the plate thickness direction, the glass plate having a refractive index distribution to increase its refractive index from a light entrance to a light exit thereof.

Further preferably, each of the optical lenses has a diameter of about 0.7 mm or greater.

The compound-eye imaging device can be designed so that the optical lens array further comprises a lens holder having holes formed in an array for holding the optical lenses, such that the optical lenses are held in the holes of the lens holder, respectively, to have optical axes L parallel to each other.

Preferably, each optical lens is formed of a molded glass material formed by vertically compressing a glass material in the thickness direction, the glass material having a refractive index distribution to increase its refractive index from a light entrance to a light exit thereof.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic side cross-sectional view of a compound-eye imaging device according to a first embodiment of the present invention along line X-X′ of FIG. 2;

FIG. 2 is a schematic plan view of the compound-eye imaging device, showing a light shielding block and a photodetector array;

FIG. 3 is a schematic block diagram of a circuit configuration connected to the compound-eye imaging device;

FIG. 4 is a schematic side cross-sectional view of a compound-eye imaging device according to a second embodiment of the present invention;

FIG. 5A is a schematic plan view of a lens holder used in the compound-eye imaging device of the second embodiment, while FIG. 5B is a schematic perspective view of a portion of the lens holder as cut along line Y-Y′ of FIG. 5A; and

FIG. 6A is an explanatory view showing an imaging mode using an optical lens according to a conventional compound-eye imaging device, while FIG. 6B is an explanatory view showing an imaging mode using an optical lens having a refractive index distribution according to the compound-eye imaging device of the second embodiment.

### DESCRIPTION OF THE PREFERRED EMBODIMENTS

Embodiments of the present invention, as best mode for carrying out the invention, will be described hereinafter with reference to the drawings. The present invention relates to a compound-eye imaging device. It is to be understood that the embodiments herein are not intended as limiting, or encompassing the entire scope of, the invention. Note that like parts are designated by like reference numerals or characters throughout the drawings.

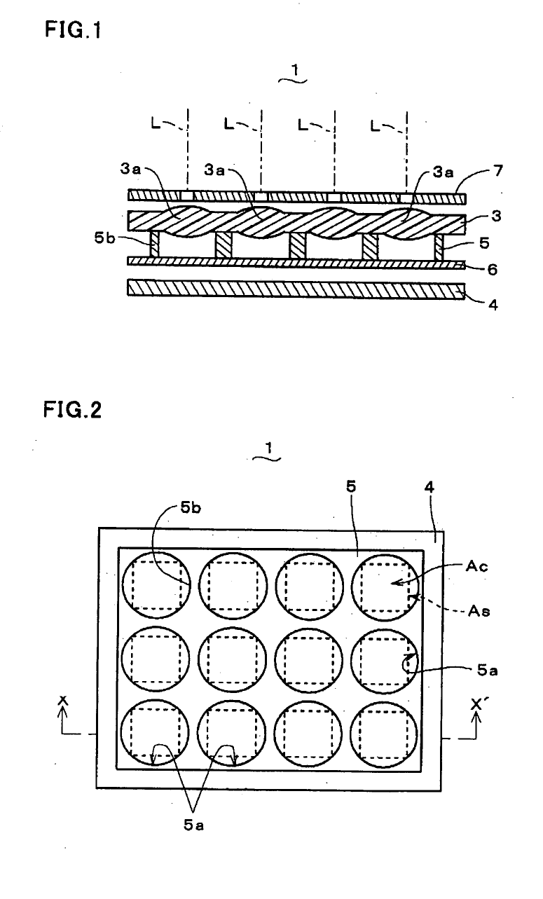

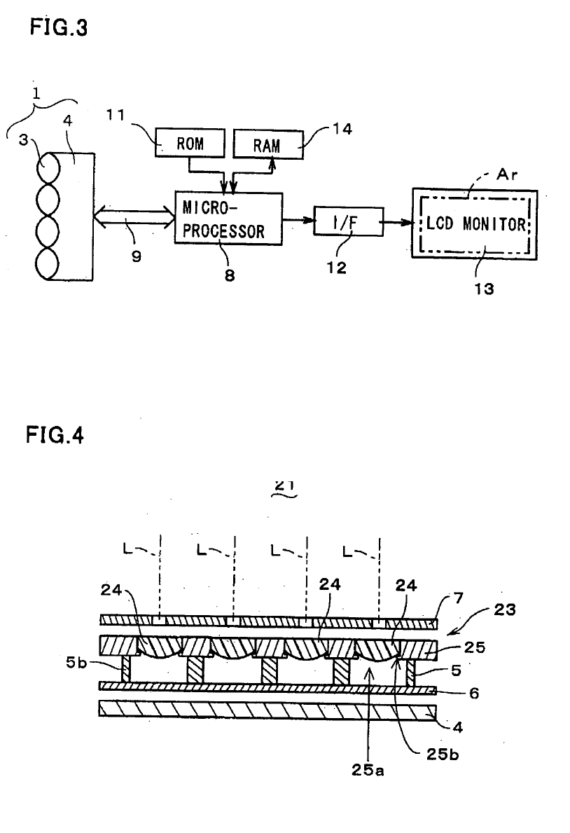

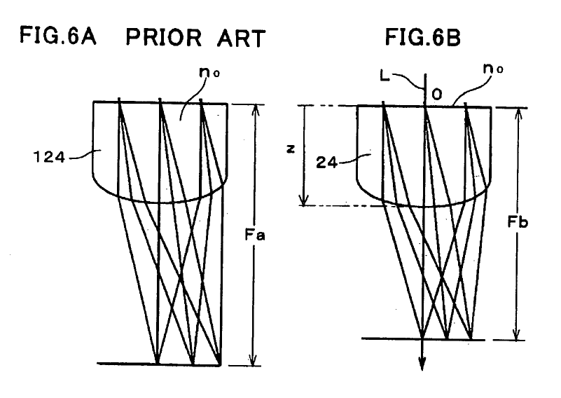

A compound-eye imaging device 1 according to a first embodiment of the present invention will be described with reference to FIG. 1, FIG. 2, FIG. 3, FIG. 6A and FIG. 6B. FIG. 1 is a schematic side cross-sectional view of the compound-eye imaging device 1 according to the first embodiment of the present invention along line X-X′ of FIG. 2, while FIG. 2 is a schematic plan view of the compound-eye imaging device 1, showing a light shielding block 5 and a photodetector array 4. As shown in FIG. 1 and FIG. 2, the compound-eye imaging device 1 comprises: an optical lens array 3 having 12 (twelve) optical lenses 3a as 12 single or unit eyes which have optical axes L parallel to each other, and which are arranged in a matrix of three rows and four columns and mutually integrally formed on one plate; and a photodetector array 4 which is placed below, and at a predetermined distance from, the optical lens array 3, and which has 12 photodetector areas, also arranged in a matrix of three rows and four columns corresponding to the optical lens array 3, for imaging 12 single-eye images Ac formed by the 12 optical lenses 3a.

The compound-eye imaging device 1 further comprises: a light shielding block 5 which is placed between the optical lens array 3 and the photodetector array 4, and which has a partition wall 5b for partitioning a space between the optical lens array 3 and the photodetector array 4 into a matrix (three rows/four columns) of spaces as seen on a plane perpendicular to the optical axis L so as to prevent lights emitted from the respective optical lenses 3a from interfering each other; an optical filter 6 placed under the light shielding block 5 for transmitting only visible light among light components emitted from the optical lenses 3a; and a stop member 7 placed above the optical lens array 3 for shielding unnecessary ambient light from entering the respective optical lenses 3a. Note that the optical filter 6 can also be a filter for transmitting only infrared light, or a filter for transmitting both visible light and infrared light.

As shown in FIG. 2, the light shielding block 5 and the photodetector array 4 are each rectangular plate-shaped, and placed to overlap each other as seen in plan view. The photodetector array 4 is formed of a semiconductor substrate which has a rectangular shape as seen in plan view, and is, for example, a CMOS (Complementary Metal Oxide Semiconductor) image sensor or a CCD (Charge Coupled Device) image sensor. The light shielding block 5 is a rectangular parallelepiped block also having a rectangular shape as seen in plan view, which however is a little smaller than that of the photodetector array 4. The light shielding block 5 is formed of a partition wall 5b which has circular apertures 5a facing the respective optical lenses 3a of the optical lens array 3, and which partitions the space between the optical lens array 3 and the photodetector array 4 into a matrix of spaces as seen on a plane perpendicular to each optical axis L.

A feature of the present embodiment is that the optical lens array 3 is formed of a glass substrate or plate having a refractive index distribution varying in the plate thickness direction. More specifically, the refractive index of the glass itself, forming the optical lenses 3a, increases in the direction of light propagation from a light entrance to a light exit (from stop member 7 to optical filter 6). The use of a glass substrate having such refractive index distribution makes it possible to reduce the focal length of each optical lens 3a with the thickness of the optical lens 3a being maintained the same. This will be described in detail later with reference to FIG. 6A and FIG. 6B, following the description of the second embodiment.

Next, a method of manufacturing an optical lens array 3 usable in the imaging device 1 according to the present embodiment will be described. First, a glass plate with a predetermined thickness having a refractive index distribution varying in the plate thickness direction is prepared. The glass plate is placed in a pair of molds respectively having female surfaces corresponding to upper and lower shapes of the optical lens array 3 with the optical lenses 3a, and is compressed by pressing the molds to each other in a direction corresponding to the plate thickness direction of the glass plate, thereby manufacturing the optical lens array 3 integrally formed with the glass substrate.

At this time, the glass plate is not only compressed but also heated to form a predetermined shape of the optical lens array 3 with the optical lenses 3a. The resultant optical lens array 3 or optical lenses 3a can have an appropriate shape such that each optical lens 3a has an appropriate combination of shapes on upper and lower surfaces of the glass substrate and hence of the optical lens array 3, such as: convexes on both upper and lower surfaces; convex on either surface and concave on the other; and convex on only one surface and flat on the other. This method of vertically compressing the glass plate in the plate thickness direction by using the molds makes it possible to easily manufacture an optical lens array 3 with optical lenses 3a each having a diameter of about 0.7 mm or greater. Further, as apparent from the above description, it is possible to manufacture an optical lens array 3 of a so-called single convex type in which convex lens shapes are formed on only one of the upper and lower surfaces of the glass plate or the resultant glass substrate.

Hereinafter, an imaging process in the compound-eye imaging device 1 of the present embodiment will be described. First, light from an object to be imaged is limited by the stop member 7 to a predetermined amount and is incident on and enters the 12 optical lenses 3a of the optical lens array 3. On the other hand, lights emitted from the respective optical lens 3a arrive on the photodetector array 4 via the optical filter 6 without interfering each other because of the partition wall 5b of the light shielding block 5 so as to each form a circular image (single-eye image) Ac, corresponding to each circular aperture 5a of the light shielding block 5, on each photodetector of the photodetector array 4.

The 12 single-eye images Ac formed on the photodetector array 4 are respectively converted to electrical signals which are output from the photodetector array 4, and are input either to a microprocessor provided on the same semiconductor substrate that forms the photodetector array 4, or to a microprocessor in e.g. an external personal computer connected via an interface to the compound-eye imaging device 1. The microprocessor in either case reconstructs the thus input electrical signals into one image to be displayed on a display unit such as an LCD (Liquid Crystal Display) monitor 13 (refer to FIG. 3 below).

FIG. 3 is a schematic block diagram of a circuit configuration which is connected to the compound-eye imaging device 1, and which includes a microprocessor 8 connected to the photodetector array 4 and an LCD monitor 13. The photodetector array 4 is connected to the microprocessor 8 via a bus 9. Based on operations of a predetermined processing program stored in a ROM (Read Only Memory) 11, the microprocessor 8 processes electrical signals of the respective single-eye images Ac input thereto from the photodetector array 4, and reconstructs the electrical signals into one image Ar, and further outputs the image Ar on the LCD monitor 13 via an interface (I/F) 12. The microprocessor 8 temporarily stores, in a RAM (Random Access Memory) 14, various computational results obtained by the operations of the processing program.

The microprocessor 8 processes the electrical signals of the single-eye images Ac in two processes: (a) a process to cut out, from each of the 12 circular single-eye images Ac, a square image As inscribed inside the circle of each circular single-eye image Ac; and (b) a process to reconstruct the thus cut-out 12 square images As into one image Ar by using parallax information between the 12 single-eye images Ac. Although the microprocessor 8 thus performs both processes in the present embodiment, it is also possible to design so that the two processes are performed by separately provided microprocessors or ICs (integrated circuits). Note that it is a well-known technology to reconstruct multiple images into one image by using parallax information between the multiple images.

As described in the foregoing, according to the compound-eye imaging device 1 of the present embodiment, the optical lens array 3 is formed of a glass substrate having a refractive index distribution varying in the substrate or plate thickness direction. More specifically, the refractive index of the glass substrate forming the optical lenses 3 increases in the direction of light propagation from a light entrance to a light exit (from stop member 7 to optical filter 6). Thus, as compared with the case of forming an optical lens array or optical lenses by using an ordinary glass material, the focal length of each optical lens 3a is reduced, thereby reducing the entire thickness of the compound-eye imaging device 1. A preferable method of forming such optical lens array is to compress and mold a glass plate in the plate thickness direction as described above.

It should be noted that the reduction of the focal length achieved by the present embodiment is not achieved by reducing the diameter of each optical lens 3a to increase the integration density of the micro optical systems. Accordingly, the reduction of focal length according to the present embodiment does not cause either a difficulty in manufacturing or a problem of taking a long time to reconstruct an image.

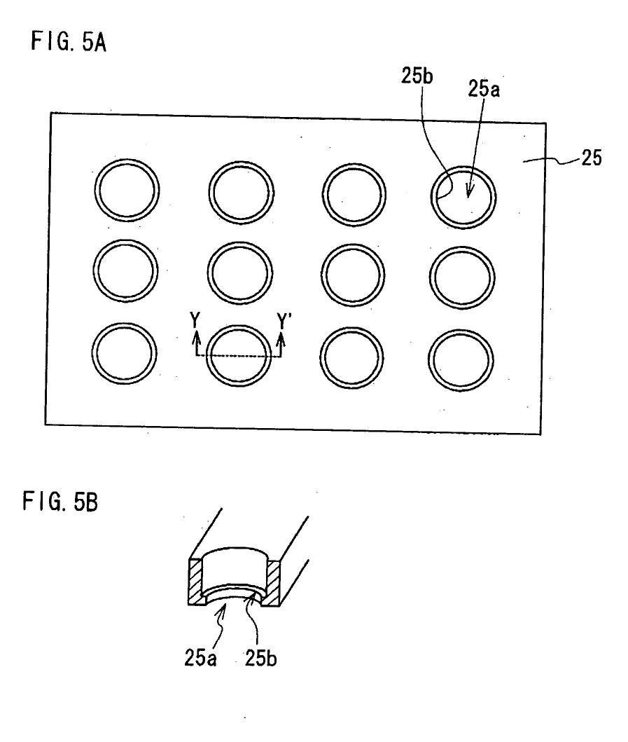

Hereinafter, a compound-eye imaging device 21 according to a second embodiment of the present invention will be described with reference to FIG. 4, FIG. 5A and FIG. 5B along with FIG. 6A and FIG. 6B. FIG. 4 is a schematic side cross-sectional view of the compound-eye imaging device 21 according to the second embodiment of the present invention. FIG. 5A is a schematic plan view of a lens holder 25 used in the compound-eye imaging device 21, while FIG. 5B is a schematic perspective view of a portion of the lens holder 25 as cut along line Y-Y′ of FIG. 5A, showing the structure of each hole 25a and inner rim 25b. The compound-eye imaging device 21 of the present embodiment has a structure the same as that of the first embodiment except for an optical lens array 23, and the same parts are designated by the same reference numerals, so that further description thereof is omitted.

Referring to FIG. 4, FIG. 5A and FIG. 5B, the optical lens array 23 in the compound-eye imaging device 21 of the second embodiment comprises a plate-shaped lens holder 25 having holes 25a formed in an array for holding optical lenses 24, respectively. The lens holder 25 holds the optical lenses 24 such that the optical lenses 24 are integrally held in the holes 25a of the lens holder 25, respectively, to have optical axes L parallel to each other. At each hole 25a, the lens holder 25 has an inner rim 25b which has a diameter smaller than that of the hole 25a, and which is provided to prevent each optical lens 24 from falling. Thus, each optical lens 24 is inserted into each hole 25a from above, and securely fixed at a predetermined position in the hole 25a without falling down.

Each optical lens 24 has a refractive index distribution varying in the thickness direction. More specifically, the refractive index of the optical lens 24 increases in the direction of light propagation from a light entrance to a light exit (from the stop member 7 to the optical filter 6). The refractive index distribution of each optical lens 24 is similar to that of each optical lens 3a. The use of such refractive index distribution makes it possible to reduce the focal length of each optical lens 24 with the thickness of the optical lens 24 being maintained the same. This will be described in more detail later with reference to FIG. 6A and FIG. 6B.

The optical lenses 24 according to the second embodiment can be manufactured in substantially the same manner as in manufacturing the optical lens array 3 according to the first embodiment. That is, first, a glass material with a predetermined thickness having a refractive index distribution varying in the thickness direction is prepared. The glass material is placed in a pair of molds respectively having female surfaces corresponding to upper and lower shapes of the optical lens 24, and is compressed by pressing the molds to each other in a direction corresponding to the thickness direction of the glass material.

At this time, the glass material is not only compressed but also heated to form a predetermined shape of the optical lens 24, more specifically a convex lens having a flat upper surface and a convex lower surface, which can be referred to as a so-called single convex type optical lens 24. By repeating this process for the number of optical lenses 24, multiple optical lenses 24 are manufactured. The optical lens array 23 is completed by mounting the thus manufactured optical lenses 24 in the holes 25a of the lens holder 25, respectively. This method of vertically compressing the glass material in the thickness direction by using the molds makes it possible to easily manufacture an optical lens 24 having a diameter of about 0.7 mm or greater.

Thus, similarly as in the case of the compound-eye imaging device 1 of the first embodiment, the focal length of each optical lens 24 in the compound-eye imaging device 21 of the second embodiment is reduced as compared with the case of forming each optical lens by using an ordinary glass material. This makes it possible to reduce the entire thickness of the compound-eye imaging device 21. Further, similarly as in the first embodiment, the reduction of focal length achieved by the present embodiment is not achieved by reducing the diameter of each optical lens 24 to increase the integration density of the micro optical systems. Accordingly, the reduction of focal length according to the present embodiment does not cause either a difficulty in manufacturing or a problem of taking a long time to reconstruct an image.

Hereinafter, the refractive index distribution of each optical lens 3a in the first embodiment and that of each optical lens 24 in the second embodiment will be described with reference to FIG. 6A and FIG. 6B. Since the former refractive index distribution is conceptually the same as that of the latter, it is deemed sufficient to describe either the former or latter. Here, the latter is used for the description. FIG. 6A is an explanatory view showing an imaging mode using an optical lens 124 having no refractive index distribution (i.e. ordinary optical lens having a uniform refractive index) according to a conventional compound-eye imaging device, while FIG. 6B is an explanatory view showing an imaging mode using an optical lens 24 having a refractive index distribution according to the compound-eye imaging device 21 of the second embodiment.

Referring to FIG. 6A and FIG. 6B, assume that the optical lens 124 according to the conventional device and the optical lens 24 according to the second embodiment have a focal length Fa and a focal length Fb, respectively, and that the optical lens 124 has a uniform refractive index no, which is the same as an initial refractive index at the light incident surface of the optical lens 24. The optical lens 24 according to the second embodiment has a refractive index distribution such that the refractive index of the optical lens 24 increases in the direction of light propagation along the optical path L. This can be expressed by the following equation:
n(z)=n₀+az
where z is coordinate position along the optical path L, n(z) is refractive index at the coordinate position z along the optical path L, n₀ is initial refractive index at z=0, and a is constant.

This equation indicates that the focal length Fb according to the second embodiment is reduced as compared with the focal length Fa according to the conventional device. For example, the focal length Fa according to the conventional device is 1.58 mm, while the focal length Fb according to the second embodiment is 1.21 mm, in the case where the optical lens 124 according to the conventional device is formed of an ordinary glass material BK7 (borosilicate crown glass), and the initial refractive index no of the optical lens 24 is the same as that of BK7.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2005-312866 filed Oct. 27, 2005, the content of which is hereby incorporated by reference.

What is claimed is:

1. A compound-eye imaging device comprising:
an optical lens array with multiple integrated optical lenses;
a stop member for shielding unnecessary ambient light from entering the optical lens array;
a photodetector array placed at a predetermined distance from the optical lens array for imaging images formed by the optical lenses, respectively; and
a light shielding block placed between the optical lens array and the photodetector array for partitioning a space between the optical lens array and the photodetector array into a matrix of spaces as seen on a plane perpendicular to the optical axis of each optical lens to prevent lights emitted from the optical lenses from interfering each other,
wherein the optical lenses of the optical lens array are formed of a molded glass having a refractive index distribution such that the refractive index of each of the optical lenses increases in the direction of light propagation from a light entrance to a light exit of the each of the optical lenses.

2. The compound-eye imaging device according to claim 1,
wherein the optical lenses have optical axes parallel to each other, and are integrally formed with a glass substrate to form the optical lens array.

3. The compound-eye imaging device according to claim 2,
wherein the optical lens array is formed of a molded glass substrate formed by vertically compressing a glass plate in the plate thickness direction, the glass plate having a refractive index distribution to increase its refractive index from a light entrance to a light exit thereof.

4. The compound-eye imaging device according to claim 3,
wherein each of the optical lenses has a diameter of about 0.7 mm or greater.

5. The compound-eye imaging device according to claim 1,
wherein the optical lens array further comprises a lens holder having holes formed in an array for holding the optical lenses, such that the optical lenses are held in the holes of the lens holder, respectively, to have optical axes L parallel to each other.

6. The compound-eye imaging device according to claim 5,
wherein each of the optical lenses is formed of a molded glass material formed by vertically compressing a glass material in the thickness direction, the glass material having a refractive index distribution to increase its refractive index from a light entrance to a light exit thereof.

7. The compound-eye imaging device according to claim 6,
wherein each of the optical lenses has a diameter of about 0.7 mm or greater.
